(19) United States
(12) Patent Application Publication
(10) Pub. No.: US 2025/0218334 A1
(43) Pub. Date: Jul. 3, 2025

(54) Frequency Variable Display Apparatus and Driving Method Thereof

(71) Applicant: LG Display Co., Ltd., Seoul (KR)

(72) Inventors: Moo Kyoung Hong, Paju-si (KR); Ui Taek Jeong, Paju-si (KR)

(21) Appl. No.: 18/966,829

(22) Filed: Dec. 3, 2024

(30) Foreign Application Priority Data
Dec. 28, 2023 (KR) 10-2023-0195450

(51) Int. Cl. G09G 3/20; G09G 3/3233

(52) U.S. Cl. CPC G09G 3/2092; G09G 3/3233; G09G 2300/0842; G09G 2310/063; G09G 2310/08; G09G 2320/0257; G09G 2320/041; G09G 2340/0435

(57) ABSTRACT

A frequency variable display apparatus includes a display panel where a plurality of pixels are provided, an image analyzer configured to analyze image data, which is to be written in the plurality of pixels, to determine whether a frame image implemented in the display panel is a still image or a moving image, and a first controller configured to fix a variable frame frequency, varying within a certain frequency range, to one reference frame frequency of the certain frequency range and implement a real-time sensing & compensation operation in a vertical blank period of a fixed frame time, while the still image is being implemented in the display panel, wherein a length of the vertical blank period of the fixed frame time is longer than or equal to a minimum desired time needed for the real-time sensing and compensation operation.

### CROSS-REFERENCE TO RELATED APPLICATION

This application claims the benefit of Republic of Korea Patent Application No. 10-2023-0195450 filed on Dec. 28, 2023, which is hereby incorporated by reference in its entirety.

### BACKGROUND

### Field of Technology

The present disclosure relates to a frequency variable display apparatus and a driving method thereof.

### Discussion of the Related Art

Frequency variable display apparatuses vary a frame frequency of an image displayed on a screen, based on an attribute of video data received from an external video source. Frequency variable display apparatuses support a variable refresh rate (VRR) function which varies a frame frequency within a predetermined frequency range.

Frequency variable display apparatuses may implement a high driving speed of a display panel through a VRR operation. A vertical blank period of a high-speed driving frame is shorter than that of a low-speed driving frame. When the vertical blank period is insufficient, it is difficult to implement a real time (RT) operation. The RT operation denotes an operation which senses and compensates for an electrical characteristic change of pixels in real time in the middle of displaying an image on a screen of a display panel.

In a case where the RT operation is omitted because the vertical blank period is insufficient, when a screen image is changed after a still image pattern is applied to a display panel, a moment afterimage may be seen at a screen position at which the still image pattern has been displayed.

### SUMMARY

To overcome the aforementioned problem of the related art, the present disclosure may provide a frequency variable display apparatus and a driving method thereof, which may prevent a moment afterimage from occurring when performing a variable refresh rate (VRR) operation.

To achieve these objects and other advantages and in accordance with the purpose of the disclosure, as embodied and broadly described herein, a frequency variable display apparatus includes a display panel where a plurality of pixels are provided, an image analyzer configured to analyze image data, which is to be written in the plurality of pixels, to determine whether a frame image implemented in the display panel is a still image or a moving image, and a first controller configured to fix a variable frame frequency, varying within a certain frequency range, to one reference frame frequency of the certain frequency range and implement a real-time sensing & compensation operation in a vertical blank period of a fixed frame time, while the still image is being implemented in the display panel, wherein a length of the vertical blank period of the fixed frame time is longer than or equal to a minimum desired time needed for the real-time sensing & compensation operation.

In another embodiment of the present disclosure, a driving method of a frequency variable display apparatus, including a display panel where a plurality of pixels are provided, includes analyzing image data, which is to be written in the plurality of pixels, to output an image analysis result representing whether a frame image implemented in the display panel is a still image or a moving image, fixing a variable frame frequency, varying within a certain frequency range, to one reference frame frequency of the certain frequency range while the still image is being implemented in the display panel, and implementing a real-time sensing and compensation operation in a vertical blank period of a fixed frame time, wherein a length of the vertical blank period of the fixed frame time is longer than or equal to a minimum desired time needed for the real-time sensing & compensation operation.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a block diagram illustrating a frequency variable display apparatus according to one embodiment of the present embodiment;

FIG. 2 is a diagram illustrating a connection configuration between pixels and a sensing circuit according to one embodiment of the present embodiment;

FIG. 3 is a diagram illustrating a detailed configuration of a timing controller according to one embodiment of the present embodiment;

FIG. 4 is a diagram illustrating a delay mode and a non-delay mode according to one embodiment of the present embodiment;

FIG. 5 is a diagram illustrating a memory operation in the delay mode according to one embodiment of the present embodiment;

FIG. 6 is a diagram illustrating a memory operation in the non-delay mode according to one embodiment of the present embodiment;

FIG. 7 is a diagram illustrating a vertical active period and a vertical blank period in a frequency variable display apparatus based on a frame frequency variation according to one embodiment of the present embodiment;

FIG. 8 is a diagram illustrating an example where it is impossible to perform a real time (RT) operation in a frequency variable display apparatus based on a length of a vertical blank period;

FIG. 9 is a diagram illustrating a driving method of a frequency variable display apparatus according to an embodiment; and

FIG. 10 is a diagram illustrating a driving method of a frequency variable display apparatus according to another embodiment.

### DETAILED DESCRIPTION

Hereinafter, the present disclosure will be described more fully with reference to the accompanying drawings, in which exemplary embodiments of the disclosure are shown. The disclosure may, however, be embodied in many different forms and should not be construed as being limited to the embodiments set forth herein; rather, these embodiments are provided so that this disclosure will be thorough and complete, and will fully convey the concept of the disclosure to those skilled in the art.

Advantages and features of the present disclosure, and implementation methods thereof will be clarified through following embodiments described with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art. Furthermore, the present disclosure is only defined by scopes of claims.

The shapes, sizes, ratios, angles, numbers and the like disclosed in the drawings for description of various embodiments of the present disclosure to describe embodiments of the present disclosure are merely exemplary and the present disclosure is not limited thereto. Like reference numerals refer to like elements throughout. Throughout this specification, the same elements are denoted by the same reference numerals. As used herein, the terms “comprise”, “having,” “including” and the like suggest that other parts can be added unless the term “only” is used. As used herein, the singular forms “a”, “an”, and “the” are intended to include the plural forms as well, unless context clearly indicates otherwise.

Elements in various embodiments of the present disclosure are to be interpreted as including margins of error even without explicit statements.

In describing a position relationship, for example, when a position relation between two parts is described as “on˜”, “over˜”, “under˜”, and “next˜”, one or more other parts may be disposed between the two parts unless “just” or “direct” is used.

It will be understood that, although the terms “first”, “second”, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure.

In the following description, when the detailed description of the relevant known function or configuration is determined to unnecessarily obscure the important point of the present disclosure, the detailed description will be omitted. Hereinafter, embodiments of the present disclosure will be described in detail with reference to the accompanying drawings.

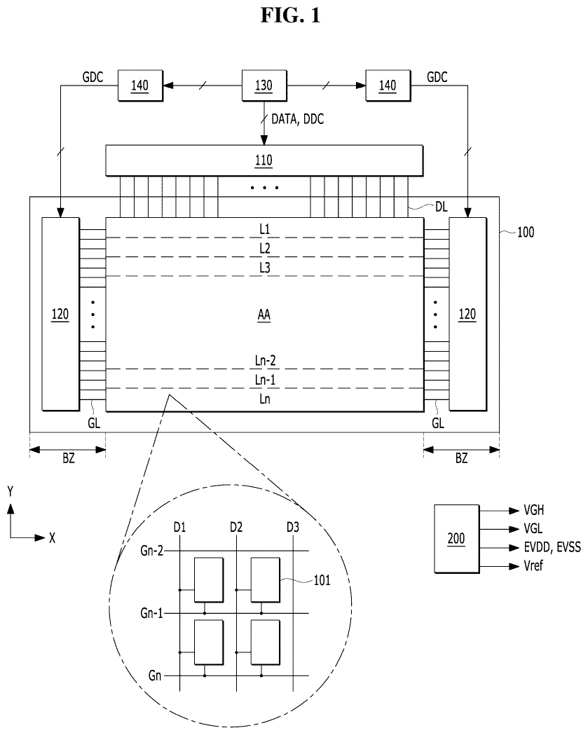

FIG. 1 is a block diagram illustrating a frequency variable display apparatus according to one embodiment of the present embodiment.

Referring to FIG. 1, a display panel 100 may include a screen AA which displays an input image. The screen AA may include a pixel array which displays pixel data (hereinafter referred to as “image data”) DATA of an input image. The pixel array may include a plurality of data lines DL, a plurality of gate lines GL intersecting with the data lines DL, a plurality of reference voltage lines, and a plurality of pixels 101.

The pixels 101 may be arranged on the screen AA in a matrix type defined by the data lines DL, the gate lines GL, and the reference voltage lines. The pixel 101 may be arranged as various types, such as a stripe type and a diamond type as well as a matrix type, on the screen AA.

The pixel array may include a plurality of pixel columns and a plurality of pixel lines L1 to Ln intersecting with the pixel columns. Each of the pixel columns may include pixels 101 which are arranged in a Y-axis direction. A pixel line may include pixels 101 which are arranged in an X-axis direction. One vertical period may be one frame period needed for writing image data DATA of one frame in all pixels 101 of the screen. One horizontal period may be a time obtained by dividing one frame period by the number of pixel lines L1 to Ln. One horizontal period may be a time needed for writing the image data DATA of one pixel line, sharing a gate line GL, in pixels of one pixel line.

The pixels 101 may include a red (R) pixel 101, a green (G) pixel 101, a blue pixel (B) 101, and a white (W) pixel 101 for implementing colors.

The frequency variable display apparatus according to the present embodiment may be implemented as an electroluminescent display apparatus. In this case, a pixel circuit of the frequency variable display apparatus may include a light emitting device, a driving element, one or more switch elements, and a capacitor. The light emitting device may be implemented as an organic light emitting diode (OLED) (or an inorganic light emitting diode). A driving current which allows the light emitting device to emit light may be adjusted based on a gate-source voltage of the driving element. Each of the driving element and the switch element may be implemented as a transistor. A semiconductor layer of the transistor may include amorphous silicon or polysilicon. A semiconductor layer of at least some of transistors may include oxide. The pixel circuit may be connected to a data line DL and a gate line GL. In FIG. 1, “D1 to D3” illustrated in a circle may be data lines, and “Gn-2 to Gn” may be gate lines. Also, each of the pixels 101 may include the same pixel circuit.

Touch sensors may be disposed on the display panel 100. The touch sensors may be arranged as an on-cell or add-on type on the screen AA of the display panel 100 or may be implemented as in-cell type touch sensors embedded in the pixel array. A touch input may be sensed through the touch sensors or may be sensed through only pixels even without touch sensors.

A source driver 110 may convert the image data DATA, received from a timing controller 130, into gamma compensation voltages by using a digital-to-analog converter (DAC) to generate data voltages. The source driver 110 may supply the data voltages to the data lines DL. The data voltages may be supplied to the data lines DL and may be applied to gate electrodes of the driving elements through the switch elements of the pixels 101. The source driver 110 may supply a reference voltage lines with a reference voltage received from the power circuit 200. The reference voltage may be supplied to the reference voltage lines and may be applied to a source electrode of the driving element through a switch element of each pixel 101.

The source driver 110 may be implemented with one or more source drive integrated circuits (ICs). The source drive IC may be connected to the timing controller 130 through a first interface circuit and may receive the image data DATA from the timing controller 130. The first interface circuit may be implemented as an embedded clock point to point interface (EPI), but is not limited thereto.

The source drive IC may be connected to the timing controller 130 through a second interface circuit and may transfer or receive real time (RT) sensing data to or from the timing controller 130. The RT sensing data may denote sensing result data which is obtained by sensing an electrical characteristic change of the pixels 101 in real time when displaying a screen. The second interface circuit may be implemented with bus low voltage differential signaling (BLVDS), but is not limited thereto. The second interface circuit may be implemented to be equal to or different from the first interface circuit.

The source drive IC may further include a touch driver. The touch driver may generate a touch sensor driving signal and may convert an electric charge variation of a touch sensor into touch raw data. The touch driver may transfer the touch raw data to a host system (not shown) through a separate interface circuit. The separate interface circuit may be implemented as a serial peripheral interface (SPI), but is not limited thereto.

A gate driver 120 may be provided in a bezel region BZ which is outside a screen and does not display an image on the display panel 100. The gate driver 120 may sequentially supply a gate signal, synchronized with data voltages, to the gate lines GL according to control by the timing controller 130. The gate signal may simultaneously activate pixels 101 of a pixel line (one of L1 to Ln) into which the data voltages are charged. The gate driver 120 may output the gate signal by using one or more shift registers and may shift the gate signal. The gate signal may include one or more scan signals and an emission control signal.

The timing controller 130 may receive video data DATA and a timing signal, synchronized with the video data DATA, from the host system (not shown). The timing signal may include a vertical synchronization signal, a horizontal synchronization signal, a clock signal, and a data enable signal. The vertical synchronization signal may define a vertical period (i.e., one frame). The horizontal synchronization signal may define a horizontal period.

The timing controller 130 may generate a source timing control signal DDC for controlling an operation timing of the source driver 110 and a gate timing control signal GDC for controlling an operation timing of the gate driver 120, based on the timing signal received from the host system.

The timing controller 130 may be divided into a display mode of writing image data DATA in a screen of the display panel 100 and a sensing mode of sensing an electrical characteristic change of the pixels 101.

In the sensing mode, the timing controller 130 may sense an electrical characteristic value of each pixel 101, calculate a compensation value for compensating for a luminance change of each pixel 101, based on a characteristic sensing value, and store the calculated compensation value in a flash memory. In the display mode, the timing controller 130 may download the compensation value from the flash memory, correct image data DATA corresponding to each pixel 101 by using the compensation value and compensate for luminance distortion caused by the electrical characteristic change of each pixel 101. Such a compensation may be referred to as external compensation technology.

The external compensation technology may include an on-sequence sensing operation, an off-sequence sensing operation, and a real-time sensing operation for an RT operation. The on-sequence sensing operation and the off-sequence sensing operation may be performed in a state where a screen is turned off, and the real-time sensing operation may be performed in a state where the screen is turned off. The real-time sensing operation may be performed in a vertical blank period where a write operation of the image data DATA corresponding to the screen of the display panel 100 is performed.

The timing controller 130 may support a variable refresh rate (VRR) function of varying a frame frequency within a predetermined frequency range. Based on the timing signal received from the host system, the timing controller 130 may detect a length change of a vertical period and may vary a frame frequency to correspond to the length change of the vertical period. The timing controller 130 may differently implement a driving speed of the display panel 100 through a VRR operation.

Because a vertical blank time of a high-speed driving frame is shorter than that of a low-speed driving frame, it may be difficult to implement a RT operation. In a case where the RT operation is omitted because the vertical blank time is insufficient, when a screen image is changed after a still image pattern is applied to a display panel, a moment afterimage may be seen at a screen position at which the still image pattern has been displayed.

To prevent the occurrence of a moment afterimage, the timing controller 130 may include a feature where a variable frame frequency varying within a certain frequency range is fixed to one reference frame frequency of the certain frequency range while a still image is being implemented in the display panel 100 and an RT operation is implemented in a vertical blank period of a fixed frame time.

Furthermore, while a moving image is being implemented in the display panel 100, the timing controller 130 may operate based on a variable frame frequency to execute a prediction-based data-temperature compensation algorithm, instead of implementing the RT operation, and thus, may control a current flowing in each pixel.

The host system be one of a television (TV), a set-top box, a navigation system, a personal computer (PC), a home theater, an automotive display system, a mobile device, and a wearable device. In the mobile device and the wearable device, the source driver 110, the timing controller 130, and a level shifter 140 may be integrated into one drive IC.

The level shifter 140 may shift a logic voltage level of the gate timing control signal GDC, output from the timing controller 130, to a gate high voltage VGH or a gate low voltage VGL to supply to the gate driver 120. A low logic voltage of the gate timing control signal GDC may be shifted to the gate logic voltage VGL, and a high logic voltage of the gate timing control signal GDC may be shifted to the gate high voltage VGH.

The power circuit 200 may generate various source voltages needed for panel driving. The power circuit 200 may generate the gate high voltage VGH and the gate low voltage VGL needed for generating of the scan signal, generate a high-level source voltage EVDD and a low level source voltage EVSS which are to be supplied to a pixel, and generate a reference voltage Vref which is to be supplied to a reference voltage line.

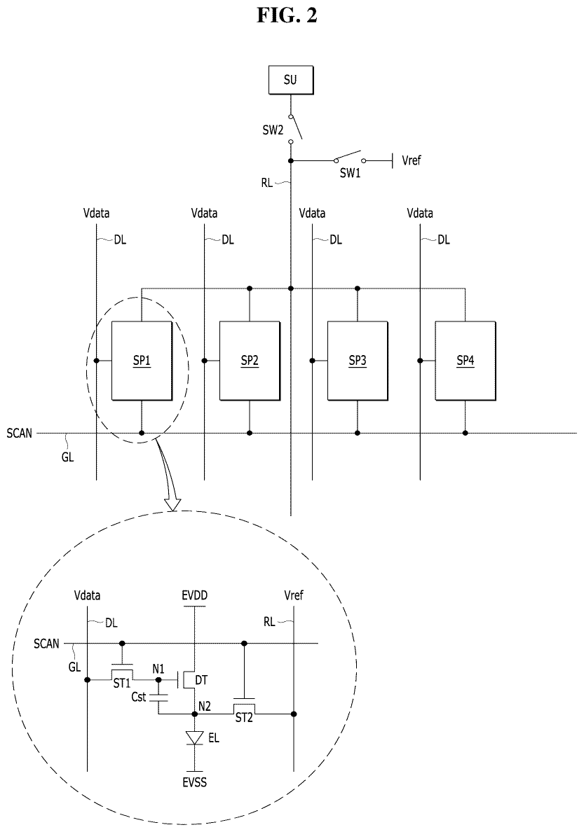

FIG. 2 is a diagram illustrating a connection configuration between pixels and a sensing circuit according to one embodiment of the present embodiment.

Referring to FIG. 2, first to fourth pixels SP1 to SP4 arranged adjacent to one another in the same pixel line may be designed to share the same reference voltage line RL, and thus, a pixel array may be simplified. The first to fourth pixels SP1 to SP4 may be R, G, B, and W pixels.

Each pixel may be implemented in a structure capable of a display operation and a sensing operation. To this end, each pixel may include a light emitting device EL, a driving transistor DT, a storage capacitor Cst, a first switch transistor ST1, and a second switch transistor ST2. The transistors DT, ST1, and ST2 may each be implemented as a thin film transistor (TFT). TFTs may be implemented as a P type, an N type, or a hybrid type where the P type and the N type are provided in common. Also, a semiconductor layer of each TFT may include amorphous silicon, polysilicon, or oxide.

The light emitting device EL may include an anode electrode connected to a source node N2, a cathode electrode connected to an input terminal of a low-level driving voltage EVSS, and an organic compound layer disposed between the anode electrode and the cathode electrode. The organic compound layer may include a hole injection layer (HIL), a hole transport layer (HTL), an emission layer (EML), an electron transport layer (ETL), and an electron injection layer (EIL).

The driving transistor DT may be a driving element which controls a level of a drain-source current (hereinafter referred to as Ids) of the driving transistor DT input to the light emitting device EL, based on a gate-source voltage (hereinafter referred to as Vgs) thereof. The driving transistor DT may include a gate electrode connected with a gate node N1, a drain electrode connected to an input terminal of a high-level driving voltage EVDD, and a source electrode connected to a source node N2.

The storage capacitor Cst may be connected between the gate node N1 and the source node N2 and may hold the Vgs of the driving transistor DT during a predetermined period.

The first switch transistor ST1 may electrically connect a data line DL with the gate node N1, based on a scan signal SCAN from a gate line GL, and may allow a data voltage Vdata to be charged into the gate node N1. The first switch transistor ST1 may include a gate electrode connected with the gate line GL, a drain electrode connected with the data line DL, and a source electrode connected with the gate node N1.

The second switch transistor ST2 may electrically connect the source node N2 with a reference voltage line RL, based on the scan signal SCAN, and thus, may allow a reference voltage Vref to be charged into the source node N2. Also, the second switch transistor ST2 may allow a source node voltage, corresponding to the Ids of the driving transistor DT, to be charged into a line capacitor of the sensing line RL. The second switch transistor ST2 may include a gate electrode connected with the gate line GL, a drain electrode connected with the reference voltage line RL, and a source electrode connected with the source node N2.

The first and second switch transistors ST1 and ST2 may be turned on based on the scan signal SCAN of a gate on voltage in a vertical active period, and thus, may connect a gate electrode of the driving transistor DT with the data line DL and may connect a source electrode of the driving transistor DT with the reference voltage line RL. Accordingly, a display programming operation of writing image data may be performed. When the display programming operation is completed in the vertical active period, the first and second switch transistors ST1 and ST2 may be turned off based on the scan signal SCAN of a gate off voltage.

The first and second switch transistors ST1 and ST2 may be turned on based on the scan signal SCAN of the gate on voltage in a vertical blank period, and thus, may connect the gate electrode of the driving transistor DT with the data line DL and may connect the source electrode of the driving transistor DT with the reference voltage line RL. Accordingly, a sensing programming operation of writing sensing data may be performed. After the sensing programming operation is performed, an RT sensing operation may be performed in a scan signal SCAN period of the gate on voltage.

The first switch SW1 and the second switch SW2 may be further connected to the reference voltage line RL. The first switch SW1 may connect an output terminal of the reference voltage Vref to the reference voltage line RL. The second switch SW2 may connect the sensing circuit SU to the reference voltage line RL.

The first switch SW1 and the second switch SW2 may operate to be opposite to each other. That is, an electrical connection between the second switch SW2 and the reference voltage line RL may be broken while the first switch SW1 is being connected to the reference voltage line RL. On the other hand, an electrical connection between the first switch SW1 and the reference voltage line RL may be broken while the second switch SW2 is being connected to the reference voltage line RL.

A sensing operation of the sensing circuit SU may be enabled while the second switch SW2 is being connected to the reference voltage line RL. The sensing circuit SU may be for an RT operation during the vertical blank period and may sense an electrical characteristic change (for example, a threshold voltage variation and an electron mobility change of the driving transistor) of the pixel.

The sensing circuit SU may be implemented as a current sensing type or may be implemented as a voltage sensing type. When an electrical characteristic value (threshold voltage and electron mobility) of the driving transistor DT is changed based on various causes, a source node voltage stored in a line capacitor LCa may vary. The sensing circuit SU may sample the source node voltage stored in a line capacitor LCa and may convert a sampled source node voltage into sensing result data (i.e., RT sensing data) of a digital signal type. The sensing circuit SU may transfer the sensing result data to the timing controller.

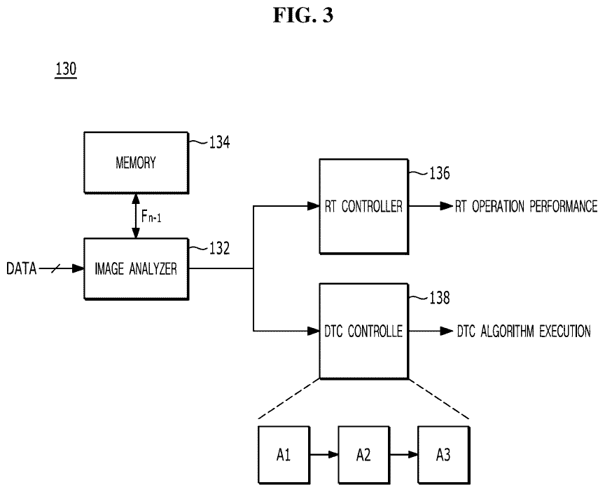

FIG. 3 is a diagram illustrating a detailed configuration of a timing controller 130 according to one embodiment of the present embodiment.

The timing controller 130 according to the present embodiment may support a VRR function, and thus, may fundamentally compensate for an electrical characteristic change of each pixel through a data-temperature compensation (DTC) operation instead of an RT operation. The DTC operation may be implemented by executing a prediction-based data-temperature compensation algorithm. However, a moment afterimage caused by a still image may not be compensated for through the DTC operation. The moment afterimage caused by the still image may be inevitably compensated for through the RT operation. Accordingly, while the VRR operation is being performed, the timing controller 130 according to the present embodiment may change a compensation control sequence, based on whether a frame image is a still image or a moving image.

To this end, as in FIG. 3, the timing controller 130 according to the present embodiment may include an image analyzer 132 (e.g., a circuit), a memory 134, an RT controller 136 (e.g., a circuit), and a DTC controller 138 (e.g., a circuit).

The image analyzer 132 may analyze image data which is to be written in pixels and may thus calculate an image analysis result representing whether a frame image implemented in a display panel is a still image or a moving image. The image analyzer 132 may analyze image data which is to be written in the pixels, with reference to the memory 134.

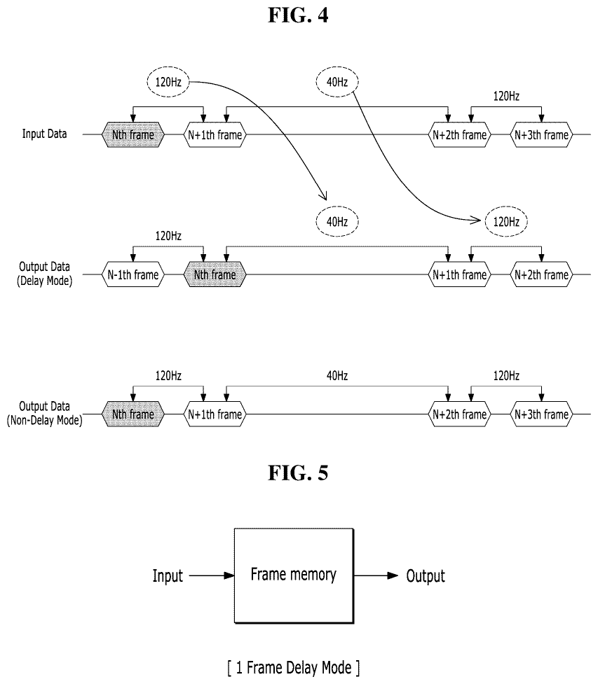

As in FIG. 4, a one frame delay mode and a non-delay mode may be implemented through the control of the memory 134.

The one frame delay mode may be used to implement a DTC operation in the DTC controller 138. To implement the one frame delay mode, as in FIG. 5, a frame memory may be used.

An operation of the DTC controller 138 may be activated based on the image analysis result from the image analyzer 132. While a moving image is being implemented in the display panel, the DTC controller 138 may operate based on a variable frame frequency to execute the prediction-based data-temperature compensation algorithm.

To execute the prediction-based data-temperature compensation algorithm, the DTC controller 138 may calculate a compensation current gain for compensating for an electrical characteristic change of the pixel, based on a frame memory of FIG. 5 operating in the one frame delay mode, and then, may reflect the compensation current gain in one frame-delayed image data (i.e., frame memory output data of FIG. 5).

The DTC controller 138 may include a current/temperature converter A1 (e.g., a circuit), a filtering unit A2 (e.g., a circuit), and a compensator A3 (e.g., a circuit).

The current/temperature converter A1 may convert a data voltage (corresponding to a display gray level of image data), which is to be supplied to each pixel, into a pixel current and may predict a target temperature corresponding to the pixel current.

The filtering unit A2 may implement an average block sampling operation and an infinite impulse response (IIR) filtering operation. The average block sampling operation may be an information compression process for implementing a temperature diffusion map and may reduce the cost by decreasing a data size. In the IIR filtering operation, time delay may be implemented through an IIR filter.

The compensator A3 may implement the temperature diffusion map which is not sharp, based on interpolation, and may perform IIR filtering on an image temperature to generate a compensation current gain for compensating for a real-time temperature afterimage.

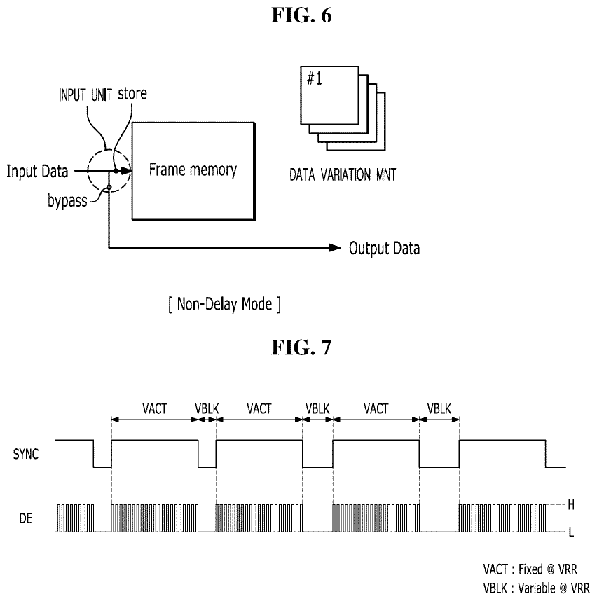

The non-delay mode may be used to implement an RT operation. A frame memory, as illustrated in FIG. 6, may be used for implementing the non-delay mode.

An operation of the RT controller 136 may be activated based on an image analysis result from the image analyzer 132. While a still image is being implemented in the display panel, the RT controller 136 may fix a variable frame frequency, varying within a certain frequency range, to one reference frame frequency of the certain frequency range and may implement a real-time sensing & compensation operation in a vertical blank period of a fixed frame time.

The certain frequency range may be, for example, 40 Hz to 480 Hz. In this case, the variable frame frequency may vary within a frequency range of 40 Hz to 480 Hz.

While a VRR operation is being performed, one vertical period (frame time) may be changed based on a variable frame frequency based on a synchronization signal SYNC. One frame time, as in FIG. 7, may be a sum of a vertical active period VACT and a vertical blank period VBLK. The vertical active period VACT and the vertical blank period VBLK in one frame time may be defined by a data enable signal DE. The data enable signal DE may define a time (i.e., a vertical active period) for which image data is transferred in a vertical period. The other time, except the vertical active period VACT, of the vertical period may be the vertical blank period VBLK. The data enable signal DE may swing from a high logic voltage H to a low logic voltage L or to be opposite thereto in the vertical active period VACT, or may not swing in the vertical blank period VBLK.

In this case, as in FIG. 6, the memory 134 may include an input unit which simultaneously perform a storage operation on image data and a bypass operation on the image data. Then, the image analyzer 132 may monitor a data variation of a frame memory illustrated in FIG. 6 and may thus analyze whether a corresponding frame image is a still image or a moving image, even without one frame delay.

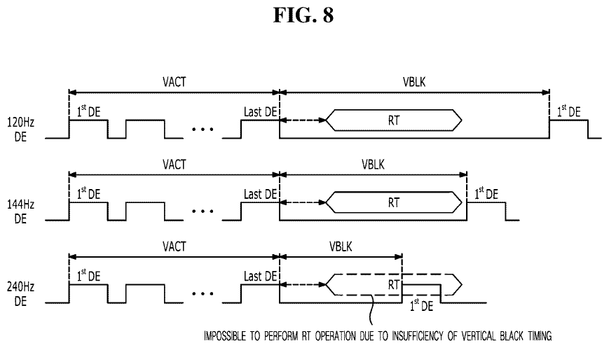

As in FIG. 8, a length of the vertical blank period VBLK may vary based on the variable frame frequency, and thus, one frame time may vary. A length of the vertical active period VACT may be fixed regardless of the variable frame frequency.

In a high-speed driving frame (for example, 240 Hz), the vertical blank period VBLK may be relatively shorter than a low-speed driving frame (for example, 120 Hz), and thus, it may be difficult to implement an RT operation. Accordingly, a length of a vertical blank period in the fixed frame time should be longer than or equal to a minimum desired time needed for the RT operation. Considering this, a reference frame frequency which defines the fixed frame time may be set to a lowest frame frequency (for example, 40 Hz) within a frequency range of 40 Hz to 480 Hz. As a fixed length of the vertical blank period where the RT operation is implemented increases, more pixel lines may be sensed for one vertical blank period, and thus, a sensing period of all pixel lines of a display panel may be reduced and the accuracy of real-time sensing may be enhanced.

When the RT operation is performed in the vertical blank period having the fixed length while the VRR operation is being performed, a sensing line compensation algorithm may be applied in real time without an error. The sensing line compensation algorithm may be technology which differentially applies a compensation gain for luminance restoration, based on a position of a pixel line where a sensing operation is performed, and thus, increases image quality (i.e., technology which allows a sensed pixel line not to be recognized). For example, when the sensing operation is performed in the vertical blank period where a length varies based on a frame frequency, it may be difficult to accurately match the compensation gain. This may be because a length of a vertical period of a corresponding frame should be known for the accurate matching of a compensation gain, but the length of the vertical period of the corresponding frame may not be known until the vertical blank period ends. Such a problem may be solved by performing an RT operation in a state where the variable frame frequency is down-fixed to a reference frame frequency as in the present embodiment.

Moreover, the RT controller 136 may convert a still image into a predetermined screen protection image before implementing the RT operation in a vertical blank period of a fixed frame time.

In one embodiment, the screen protection image is implemented as a black image. When the screen protection image is implemented as the black image, a sensed pixel line may not be recognized, and a moment afterimage may be removed in an earlier time.

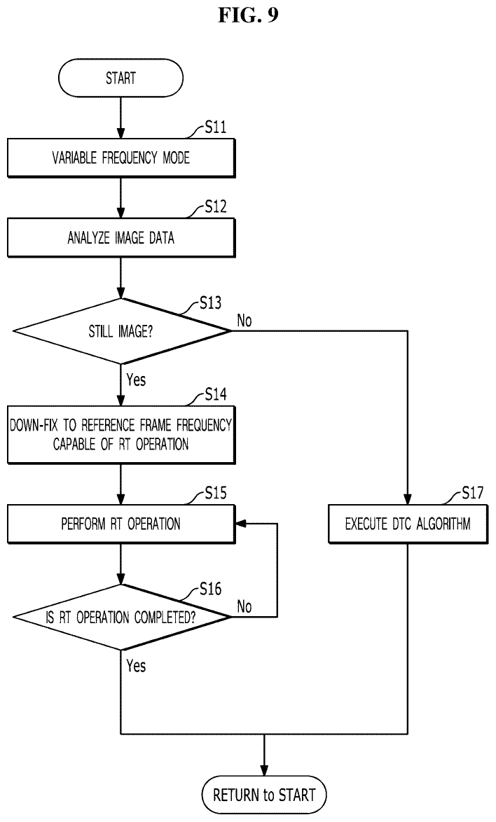

FIG. 9 is a diagram illustrating a driving method of a frequency variable display apparatus according to an embodiment.

Referring to FIG. 9, the driving method of the frequency variable display apparatus according to an embodiment may analyze image data, which is to be written in pixels in a variable frequency mode, to output an image analysis result representing whether a frame image implemented in a display panel is a still image or a moving image (S11 and S12).

The driving method of the frequency variable display apparatus according to an embodiment may fix a variable frame frequency, varying within a certain frequency range, to one reference frame frequency of the frequency range while a still image based on the image analysis result is being implemented in the display panel. In this case, the reference frame frequency may be selected as a lowest frame frequency within the frequency range. Also, a length of a vertical blank period in the fixed frame time may be longer than or equal to a minimum desired time needed for a real-time sensing & compensation operation (RT operation) (S13 and S14).

The driving method of the frequency variable display apparatus according to an embodiment may perform and complete the real-time sensing & compensation operation (RT operation) in a vertical blank period of a fixed frame time (S15 and S16).

Moreover, while a moving image based on the image analysis result is being implemented in the display panel, the driving method of the frequency variable display apparatus according to an embodiment may perform an operation based on the variable frame frequency to execute the prediction-based data-temperature compensation algorithm (S17).

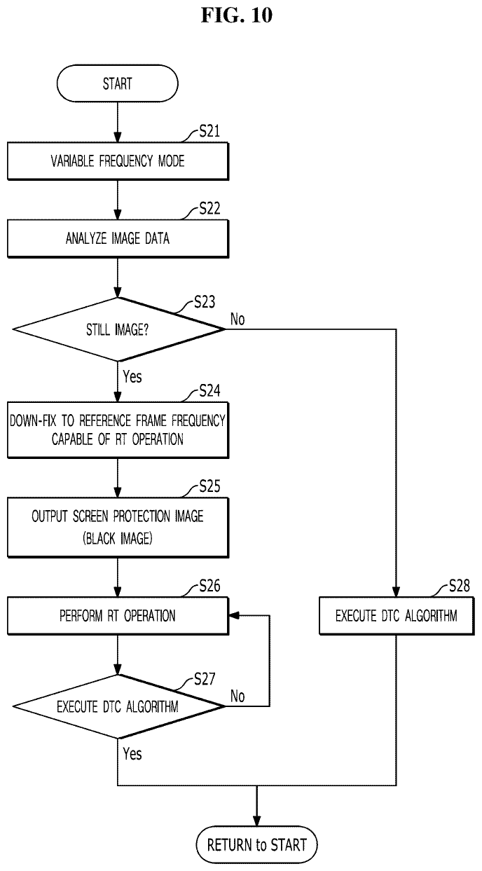

FIG. 10 is a diagram illustrating a driving method of a frequency variable display apparatus according to another embodiment.

Referring to FIG. 10, the driving method of the frequency variable display apparatus according to another embodiment may analyze image data, which is to be written in pixels in a variable frequency mode, to output an image analysis result representing whether a frame image implemented in a display panel is a still image or a moving image (S21 and S22).

The driving method of the frequency variable display apparatus according to another embodiment may fix a variable frame frequency, varying within a certain frequency range, to one reference frame frequency of the frequency range while a still image based on the image analysis result is being implemented in the display panel. In this case, the reference frame frequency may be selected as a lowest frame frequency within the frequency range. Also, a length of a vertical blank period in the fixed frame time may be longer than or equal to a minimum desired time needed for a real-time sensing & compensation operation (RT operation) (S23 and S24).

The driving method of the frequency variable display apparatus according to another embodiment may convert the still image into a screen protection image. In this case, the screen protection image may be a black image (S25).

The driving method of the frequency variable display apparatus according to another embodiment may perform and complete the real-time sensing & compensation operation (RT operation) in a vertical blank period of a fixed frame time where the black image is implemented (S26 and S27).

Moreover, while a moving image based on the image analysis result is being implemented in the display panel, the driving method of the frequency variable display apparatus according to another embodiment may perform an operation based on the variable frame frequency to execute the prediction-based data-temperature compensation algorithm (S28).

The present embodiment may realize the following effect.

The present embodiment may prevent a moment afterimage from occurring when performing a VRR operation, thereby increasing display quality.

The effects according to the present disclosure are not limited to the above examples, and other various effects may be included in the specification.

While the present disclosure has been particularly shown and described with reference to exemplary embodiments thereof, it will be understood by those of ordinary skill in the art that various changes in form and details may be made therein without departing from the spirit and scope of the present disclosure as defined by the following claims.

What is claimed is:

1. A frequency variable display apparatus comprising:
a display panel including a plurality of pixels;
an image analyzer circuit configured to analyze image data, which is to be written in the plurality of pixels, to determine whether a frame image implemented in the display panel is a still image or a moving image; and
a first controller configured to fix a variable frame frequency, varying within a certain frequency range, to one reference frame frequency of the certain frequency range and implement a real-time sensing and compensation operation in a vertical blank period of a fixed frame time, while the still image is being implemented in the display panel,
wherein a length of the vertical blank period of the fixed frame time is longer than or equal to a minimum desired time needed for the real-time sensing and compensation operation.

2. The frequency variable display apparatus of claim 1, wherein the one reference frame frequency is selected as a lowest frame frequency within the certain frequency range.

3. The frequency variable display apparatus of claim 1, wherein the first controller converts the still image into a screen protection image before implementing the real-time sensing and compensation operation in the vertical blank period of the fixed frame time.

4. The frequency variable display apparatus of claim 3, wherein the screen protection image is a black image.

5. The frequency variable display apparatus of claim 1, further comprising:
a second controller configured to, while the moving image is being implemented in the display panel, operate based on the variable frame frequency to execute a prediction-based data-temperature compensation algorithm.

6. The frequency variable display apparatus of claim 1, wherein the image analyzer circuit analyzes image data which is to be written in the plurality of pixels, with reference to a memory, and
the memory comprises an input unit configured to simultaneously perform a storage operation on the image data and a bypass operation on the image data.

7. A driving method of a frequency variable display apparatus including a display panel comprising a plurality of pixels, the driving method comprising:
analyzing image data, which is to be written in the plurality of pixels, to output an image analysis result representing whether a frame image implemented in the display panel is a still image or a moving image;
fixing a variable frame frequency, varying within a certain frequency range, to one reference frame frequency of the certain frequency range while the still image is being implemented in the display panel; and
implementing a real-time sensing and compensation operation in a vertical blank period of a fixed frame time,
wherein a length of the vertical blank period of the fixed frame time is longer than or equal to a minimum desired time needed for the real-time sensing and compensation operation.

8. The driving method of claim 7, wherein the one reference frame frequency is selected as a lowest frame frequency within the certain frequency range.

9. The driving method of claim 7, further comprising:
converting the still image into a screen protection image before implementing the real-time sensing and compensation operation in the vertical blank period of the fixed frame time.

10. The driving method of claim 9, wherein the screen protection image is a black image.

11. The driving method of claim 7, further comprising:
while the moving image is being implemented in the display panel, operating based on the variable frame frequency to execute a prediction-based data-temperature compensation algorithm.
